(19) United States
(12) Patent Application Publication
(10) Pub. No.: US 2024/0427084 A1
(43) Pub. Date: Dec. 26, 2024

(54) MODE CONVERTER AND OPTICAL COMPONENTS INCLUDING MODE CONVERTER

(71) Applicant: NIPPON TELEGRAPH AND TELEPHONE CORPORATION, Tokyo (JP)

(72) Inventors: Yoko YAMASHITA, Musashino-shi, Tokyo (JP); Takayoshi MORI, Musashino-shi, Tokyo (JP); Takashi MATSUI, Musashino-shi, Tokyo (JP); Kazuhide NAKAJIMA, Musashino-shi, Tokyo (JP)

(73) Assignee: NIPPON TELEGRAPH AND TELEPHONE CORPORATION, Tokyo (JP)

(21) Appl. No.: 18/701,805

(22) PCT Filed: Oct. 28, 2021
(86) PCT No.: PCT/JP2021/039880

§ 371 Date: Apr. 16, 2024

(51) Int. Cl. G02B 6/14

(52) U.S. Cl. CPC G02B 6/14

(57) ABSTRACT

The present disclosure aims to provide a short optical fiber-type mode converter having small wavelength dependency.

The present disclosure is about a mode converter including a cladding having a constant refractive index, a core having a refractive index higher than the refractive index of the cladding in the cladding, and a refractive index modulation part provided to obliquely cross the core and having a different refractive index from a refractive index of surroundings.

### TECHNICAL FIELD

The present disclosure relates to an optical fiber-type mode converter and an optical component including the mode converter.

### BACKGROUND ART

In order to reduce an inter-mode loss difference and an inter-mode group delay difference, a mode converter that shuffles modes within an optical path has been proposed. The mode converters are roughly classified into a device-type mode converter using a planar light wave circuit (see, for example, Non Patent Literature 1) and an optical fiber-type mode converter using an optical fiber (see, for example, Non Patent Literature 2).

In the device-type mode converter, there is an increase in an insertion loss and an inter-mode loss difference caused by mismatch of mode field diameters at a connection point with an optical fiber. On the other hand, an optical fiber-type mode converter without such a problem conventionally uses a long-period fiber grating (LPG).

### CITATION LIST

### Non Patent Literature

Non Patent Literature 1: Y. Zhao et al., Broadband and low-loss mode scramblers using CO2-laser inscribed long-period gratings, optics letters, vol. 42, no. 12, pp. 2868-2871 Non Patent Literature 2: T. Fujisawa et al, Wavefront-matching-method-designed six-mode-exchanger based on grating-like waveguide on silica-PLC platform, OFC 2020, Th1A.5.

### SUMMARY OF INVENTION

### Technical Problem

However, the optical fiber-type mode converter using LPG has a problem that it has high wavelength dependency and a length thereof is as long as about 24 mm.

Therefore, in order to solve the above-described problem, an object of the present disclosure is to provide an optical fiber-type mode converter having low wavelength dependency and a short length. In addition, another object of the present disclosure is to provide various optical components including the mode converter.

### Solution to Problem

In order to solve the above problem, the mode converter of the present disclosure includes a refractive index modulation part that obliquely crosses the core of an optical fiber.

Specifically, the mode converter of the present disclosure includes a cladding having a constant refractive index, a core having a refractive index higher than the refractive index of the cladding in the cladding, and a refractive index modulation part provided to obliquely cross the core and having a different refractive index from a refractive index of surroundings.

With such a structure, the mode converter of the present disclosure can be configured to have small wavelength dependency and a short length.

Furthermore, the mode converter of the present disclosure includes the core having a structure in which propagation in two LP modes is performed, and satisfies

$$d / {r}_{c} >= 1.1 , \\ 1 deg < θ < 2 deg , \\ {r}_{y} / {r}_{c} < {a ( {r}_{x} / {r}_{c} )}^{b} , \\ if 0 < δ n < 0.005 , \\ a = - 55 δ n + 0.36 and \\ b = - 95 δ n - 0.5 , and \\ if - 0.006 < δ n < 0 , \\ a = 39 δ n + 0.29 and \\ b = 32 δ n - 0.69 .$$

Here, d is a distance between the center of an end of the refractive index modulation part and the long axis of the core, r_{c} is a radius of the core, θ is an angle formed by the long axis of the refractive index modulation part and the long axis of the core, δn is a refractive index modulation amount, rₓ is a radius of the refractive index modulation part in an x direction, r_{y} is a radius of the refractive index modulation part in a y direction, the refractive index modulation amount is a difference between the refractive index of the refractive index modulation part and the refractive index of surroundings of the refractive index modulation part, the x direction is a direction that is parallel to the plane including the long axis of the core and the long axis of the refractive index modulation part and perpendicular to the long axis of the core, and the y direction is a direction perpendicular to the plane including the long axis of the core and the long axis of the refractive index modulation part.

In addition, the mode converter of the present disclosure has the core having a structure in which propagation in four LP modes is performed, and satisfies

$$d / {r}_{c} >= 1.4 , \\ 1 deg < θ < 2 deg , \\ {r}_{y} / {r}_{c} < {a ( {r}_{x} / {r}_{c} )}^{b} \\ if 0 < δ n < 0.007 , \\ a = - 123.8 δ n + 1.21 and \\ b = 421.5 δ n - 3.53 , and \\ if - 0.005 < δ n < 0 , \\ a = 42.6 δ n + 0.3 and \\ b = - 96.5 δ n - 1.4 .$$

Here, d is a distance between the center of an end of the refractive index modulation part and the long axis of the core, r_{c} is a radius of the core, θ is an angle formed by the long axis of the refractive index modulation part and the long axis of the core, δn is a refractive index modulation amount, rₓ is a radius of the refractive index modulation part in an x direction, r_{y} is a radius of the refractive index modulation part in a y direction, the refractive index modulation amount is a difference between the refractive index of the refractive index modulation part and the refractive index of surroundings of the refractive index modulation part, the x direction is a direction that is parallel to the plane including the long axis of the core and the long axis of the refractive index modulation part and perpendicular to the long axis of the core, and the y direction is a direction perpendicular to the plane including the long axis of the core and the long axis of the refractive index modulation part.

In addition, the present disclosure is about an optical fiber transmission line, in which

the mode converter according to any one of the above-described aspects is provided in multiple stages in the middle of an optical fiber.

In addition, the present disclosure is about an optical connector, in which

the mode converter according to any one of the above-described aspects is provided in a ferrule.

In addition, the present disclosure is about an optical adapter, in which

the mode converter according to any one of the above-described aspects is provided on an optical propagation path.

In addition, the present disclosure is about an optical amplifier, in which

the mode converter according to any one of the above-described aspects is provided on an optical propagation path.

In addition, the present disclosure is about a mode multiplexer/demultiplexer, in which the mode converter according to any one of the above-described aspects is provided at a multi-mode end.

Note that the above-described inventions can be combined where possible.

### Advantageous Effects of Invention

According to the present disclosure, it is possible to provide an optical fiber-type mode converter having low wavelength dependency and a short length.

### BRIEF DESCRIPTION OF DRAWINGS

FIG. 1 is a diagram for describing a configuration of a mode converter of the present disclosure.

FIG. 2 is a diagram for describing propagation distance dependency of excitation efficiency of the mode converter of the present disclosure.

FIG. 3 is a diagram for describing an electric field distribution of the mode converter of the present disclosure.

FIG. 4 is a diagram for describing conversion efficiency and insertion loss of the mode converter of the present disclosure.

FIG. 5 is a diagram for describing conversion efficiency and insertion loss of the mode converter of the present disclosure.

FIG. 6A is a diagram for describing conversion efficiency and insertion loss of the mode converter of the present disclosure.

FIG. 6B is a diagram for describing conversion efficiency and insertion loss of the mode converter of the present disclosure.

FIG. 7A is a diagram for describing conversion efficiency and insertion loss of the mode converter of the present disclosure.

FIG. 7B is a diagram for describing conversion efficiency and insertion loss of the mode converter of the present disclosure.

FIG. 8 is a diagram for describing refractive index modulation amount dependency of the mode converter of the present disclosure.

FIG. 9 is a diagram for describing excitation efficiency in a mode of the mode converter of the present disclosure.

FIG. 10 is a diagram for describing conversion efficiency and insertion loss of the mode converter of the present disclosure.

FIG. 11 is a diagram for describing conversion efficiency and insertion loss of the mode converter of the present disclosure.

FIG. 12A is a diagram for describing conversion efficiency and insertion loss of the mode converter of the present disclosure.

FIG. 12B is a diagram for describing conversion efficiency and insertion loss of the mode converter of the present disclosure.

FIG. 13A is a diagram for describing conversion efficiency and insertion loss of the mode converter of the present disclosure.

FIG. 13B is a diagram for describing conversion efficiency and insertion loss of the mode converter of the present disclosure.

FIG. 14 is a diagram for describing refractive index modulation amount dependency of the mode converter of the present disclosure.

FIG. 15 is a diagram for describing wavelength characteristics of the mode converter of the present disclosure.

FIG. 16 is a diagram for describing wavelength characteristics of the mode converter of the present disclosure.

FIG. 17 illustrates an example in which the mode converters of the present disclosure are provided in multiple stages in an optical fiber transmission line.

FIG. 18 illustrates an example in which the mode converter of the present disclosure is disposed in an optical connector.

FIG. 19 illustrates an example in which the mode converter of the present disclosure is disposed in an optical adapter.

FIG. 20 illustrates an example in which the mode converter of the present disclosure is disposed in an optical amplifier.

FIG. 21 illustrates an example in which the mode converter of the present disclosure is disposed in a mode multiplexer/demultiplexer.

### DESCRIPTION OF EMBODIMENTS

Hereinafter, embodiments of the present disclosure will be described in detail with reference to the drawings. Note that the present disclosure is not limited to the embodiments described below. These embodiments are merely examples, and the present disclosure can be carried out in forms with various modifications and improvements based on the knowledge of those skilled in the art. Note that components having the same reference numerals in the present specification and the drawings indicate the same components.

### First Embodiment

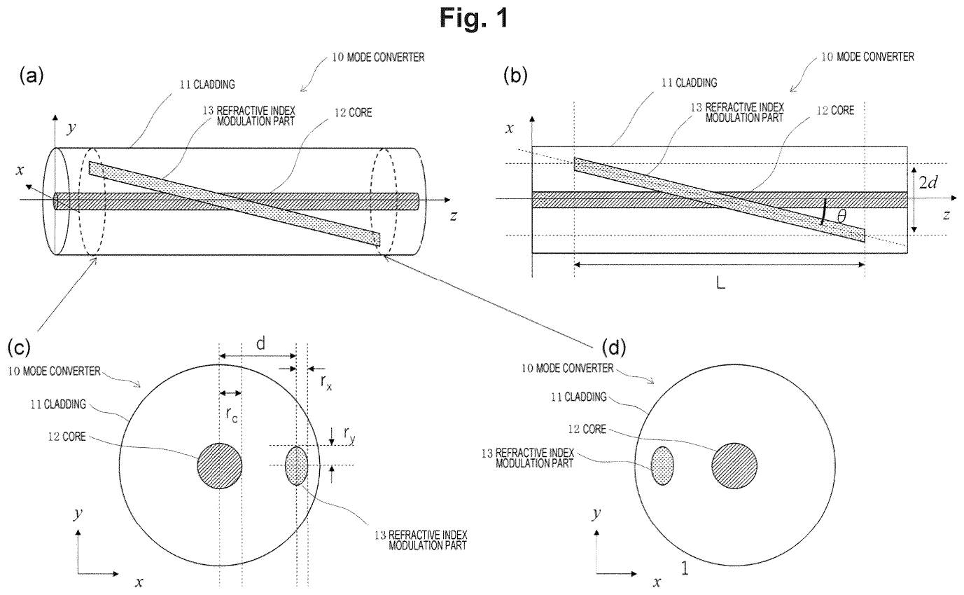

FIG. 1 illustrates a configuration of a mode converter of the present disclosure. FIG. 1(a) is an overall view, FIG. 1(b) is an x-z cross-sectional view at y=0, and FIG. 1(c) and FIG. 1(d) are x-y cross-sectional views of a start point and an end point of a light modulation part as viewed from the right side of the drawing. In FIG. 1, reference numeral 10 denotes a mode converter, reference numeral 11 denotes a cladding, reference numeral 12 denotes a core, and reference numeral 13 denotes a refractive index modulation part.

The mode converter of the present disclosure includes a cladding 11 having a constant refractive index, a core 12 having a refractive index larger than the refractive index of the cladding 11 in the cladding 11, and a refractive index modulation part 13 provided to obliquely cross the core 12 and having a refractive index different from a refractive index of surroundings. The radius of the core 12 is r_{c}, the refractive index of the core 12 is n_{core}, the refractive index of the cladding 11 is n_{clad}, the radius of the refractive index modulation part 13 in the x direction is rₓ, and the radius thereof in the y direction is r_{y}. The x direction is a direction parallel to a plane including the long axis of the core 12 and the long axis of the refractive index modulation part 13 and perpendicular to the long axis of the core 12. The y direction is a direction perpendicular to a plane including the long axis of the core 12 and the long axis of the refractive index modulation part 13.

A refractive index modulation amount of the refractive index modulation part 13 is denoted by δn. The refractive index modulation amount δn is a difference between the refractive index of the refractive index modulation part and the refractive index of the surroundings of the refractive index modulation part. The refractive index of the refractive index modulation part may be higher or lower than the refractive index of the surroundings. The refractive index of the refractive index modulation part 13 is different from the refractive index of the core 12 in the core 12, and is different from the refractive index of the cladding 11 in the cladding 11. The refractive index modulation part 13 can be manufactured by, for example, processing with a femtosecond laser. When processing is performed with a femtosecond laser, the refractive index of the refractive index modulation part 13 becomes higher than that before processing, and the refractive index of the refractive index modulation part 13 is higher than the refractive index of the core 12 by the refractive index modulation amount δn in the core 12, and is higher than the refractive index of the cladding 11 by the refractive index modulation amount δn in the cladding 11. The refractive index modulation part 13 may have a columnar shape. Examples thereof include an elliptic cylinder, a cylinder, and a prism. In the embodiment, the shape of the refractive index modulation part 13 is simulated as an elliptic cylinder.

The refractive index modulation part 13 is provided from a position at which the center of the end thereof is separated from the center of the core 12 by a distance d μm to a position at which the center passes through the center of the core 12 and is separated from the center of the core by the distance d μm on the opposite side, and the long axis of the refractive index modulation part 13 and the long axis of the core 12 are provided at an angle θ. The length L of the refractive index modulation part 13 in the long axis direction at this time is expressed by the following expression.

$$L = 2 d / tan θ$$

Although the single core structure is illustrated in FIG. 1, a multi-core structure having a plurality of cores may be used. In the case of the multi-core structure, a refractive index modulation part is provided for each core under the same condition as the single core structure. In the embodiment, although the calculation is performed using the optical fiber of the step index type, the same effect can be obtained with other refractive index distributions such as the graded index type.

### Second Embodiment

An optical fiber in which two modes of LP₀₁ and L₁₁ modes propagate is considered. Considering two-mode transmission in the C-band (1530 nm to 1565 nm), r_{c}=6.5 μm, n_{core}=1.45003, and n_{clad}=1.444 (Δ_{core}=0.4%) are set. Here, the relationship among n_{core}, n_{clad}, and Δ_{core} is expressed as follows.

$${Δ}_{core} = {( ( {n}_{core}^{2} - {n}_{clad}^{2} ) / 2 {n}_{core}^{2} )}^{1 / 2}$$

When one scanning is performed with the femtosecond laser, a refractive index modulation part having approximately rₓ=1.4 μm and r_{y}=2.1 μm can be produced. It is possible to control the refractive index modulation amount by performing processing in an overlapping manner a plurality of times.

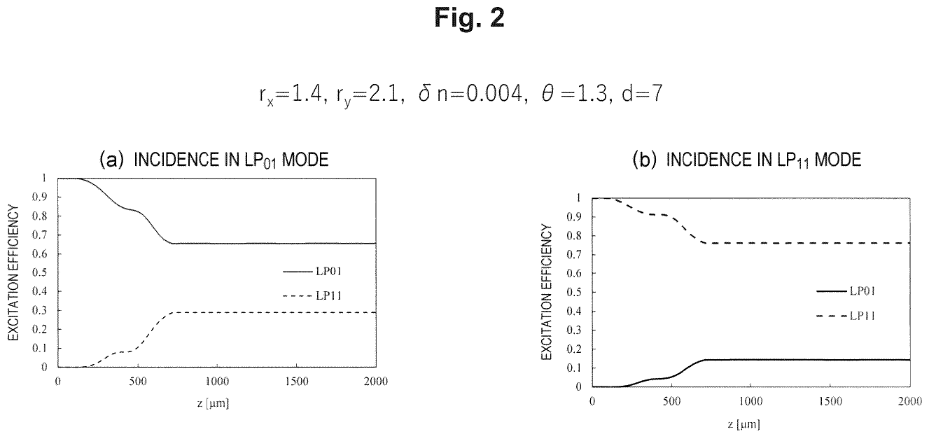

FIG. 2 illustrates, when d=7 μm, δn=0.004, and θ=1.3 deg are set so as to cross the core, the propagation distance dependence of the excitation efficiency in the cases of incidence in the LP₀₁ mode and the LP₁₁ mode. FIG. 2(a) illustrates the excitation efficiency in the case of incidence in the LP₀₁ mode, and FIG. 2(b) illustrates the excitation efficiency in the case of incidence in the LP₁₁ mode. z=200 μm is the start point of the refractive index modulation part, and z=817 μm is the end point of the refractive index modulation part. An excitation efficiency refers to a ratio of the power of the excitation mode to the power of the incidence mode.

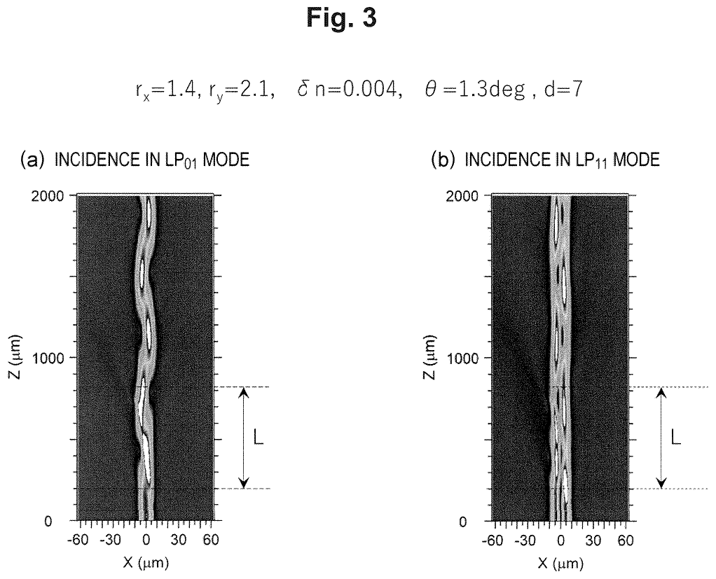

An electric field distribution at this time is shown in FIG. 3. FIG. 3(a) illustrates the electric field distribution in the case of incidence in the LP₀₁ mode, and FIG. 3(b) illustrates the electric field distribution in the case of incidence in the LP₁₁ mode. A state in which the mode has been converted and the electric field distribution has been changed can be confirmed.

According to FIG. 2, the conversion efficiency in the case of incidence in the LP₀₁ mode is 28.98, and the conversion efficiency in the case of incidence in the LP₁₁ mode is 14.4%. A conversion efficiency refers to the ratio of a total power of the mode in which light is newly excited by passing through the refractive index modulation part to a power of the incidence mode. Insertion losses at this time are 0.24 dB and 0.42 dB, respectively. Note that an insertion loss is represented by an output power normalized by an incidence power (the total in the two modes). Since the LP₁₁ mode has a smaller conversion efficiency and a larger insertion loss than the LP₀₁ mode, the respective parameters are evaluated using the conversion efficiency and the insertion loss in the case of incidence in the LP₁₁ mode having a worse characteristic under the condition of propagation in the subsequent two LP modes.

A greater conversion efficiency is desirable, and on the other hand, a smaller insertion loss is desirable Considering arranging a plurality of mode converters in the transmission path, the insertion loss is desirably at least 0.5 dB or less.

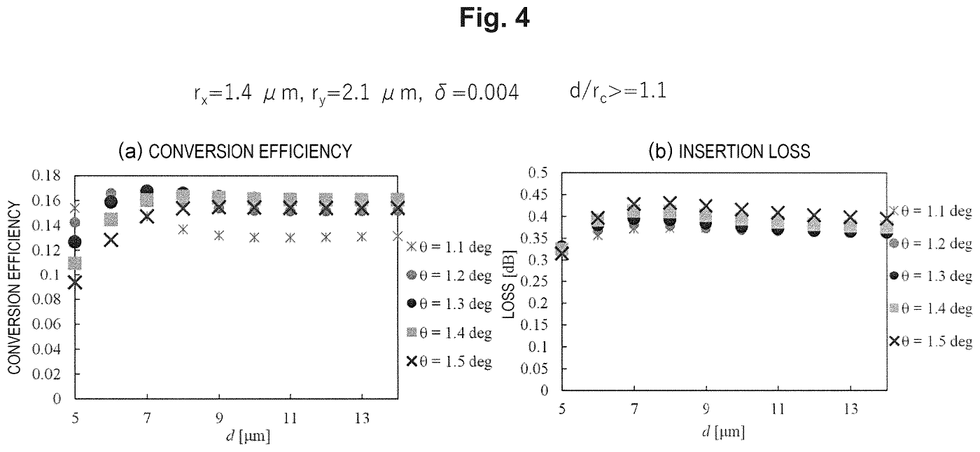

The effective range of each parameter was checked. First, the characteristic dependence on the distance d from the center of the core to the start point and the end point of the refractive index modulation part was evaluated. Here, rₓ=1.4 μm, r_{y}=2.1 μm, and δn=0.004 were set. FIG. 4(a) illustrates the conversion efficiency and FIG. 4(b) illustrates the insertion loss when the distance d is changed in the incidence in the LP₁₁ mode to the two-LP mode optical fiber. It can be confirmed that, in the region of d<7 μm, the conversion efficiency monotonically increased as the distance d increases, and the conversion efficiency was saturated around 7 μm. In addition, no large fluctuation was observed in the insertion loss in the region of d>=7 μm likewise. This shows that it is desirable to convert the mode in the range of d>=7 μm. When normalization is performed with the core radius r_{c}=6.5 μm, mode conversion can be performed with high efficiency in the range of d/r_{c}>=1.1.

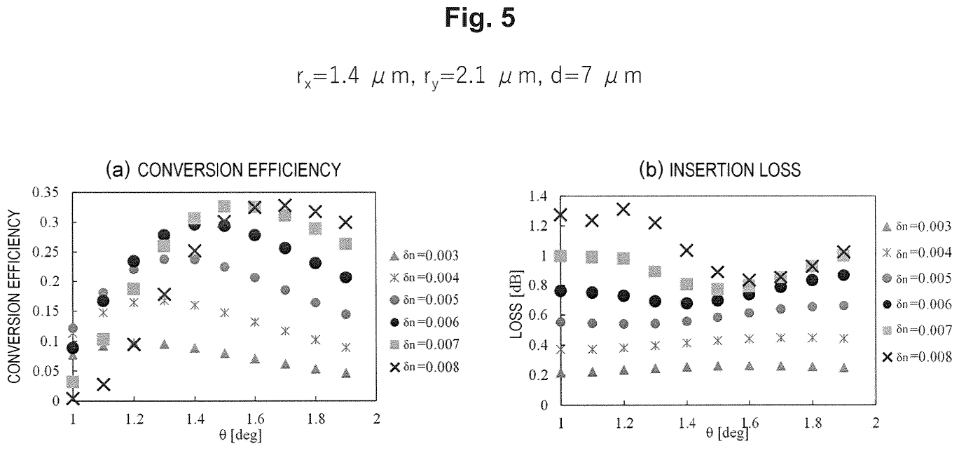

Subsequently, the characteristic dependence on the angle θ between the long axis of the core and the long axis of the refractive index modulation part was evaluated. Here, rₓ=1.4 μm, r_{y}=2.1 μm, and d=7 μm were set. FIG. 5(a) illustrates the conversion efficiency and FIG. 5(b) illustrates the insertion loss when the angle @ is changed in the incidence in the LP₁₁ mode to the two-LP mode optical fiber. It can be seen from FIG. 5(a) that the maximum value of the conversion efficiency is within the range of 1 deg<θ<2 deg. In addition, it can be seen that dependence of the insertion loss on the angle θ is small. Therefore, it is necessary to satisfy 1 deg<θ<2 deg. At this time, the length of the mode converter in the long axis direction is L=400 to 800 μm, and it is possible to realize a mode converter having a short length of about 1/30 as compared with an optical fiber-type mode converter using LPG of the related art.

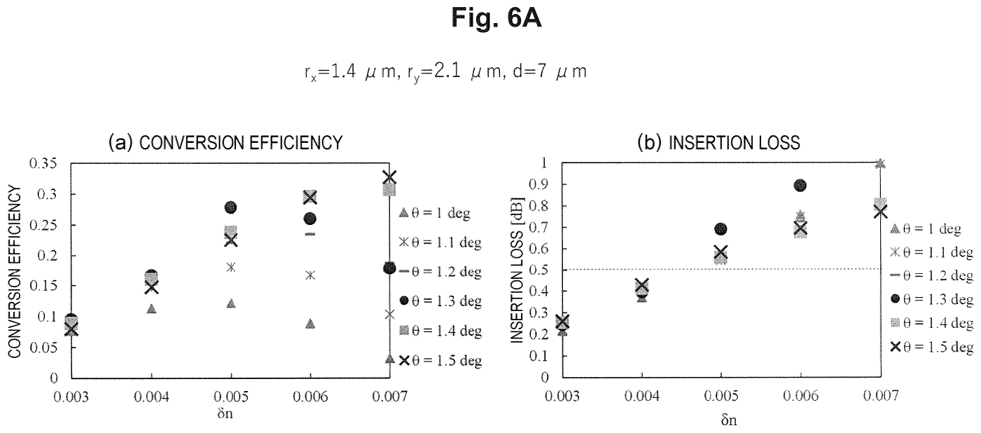

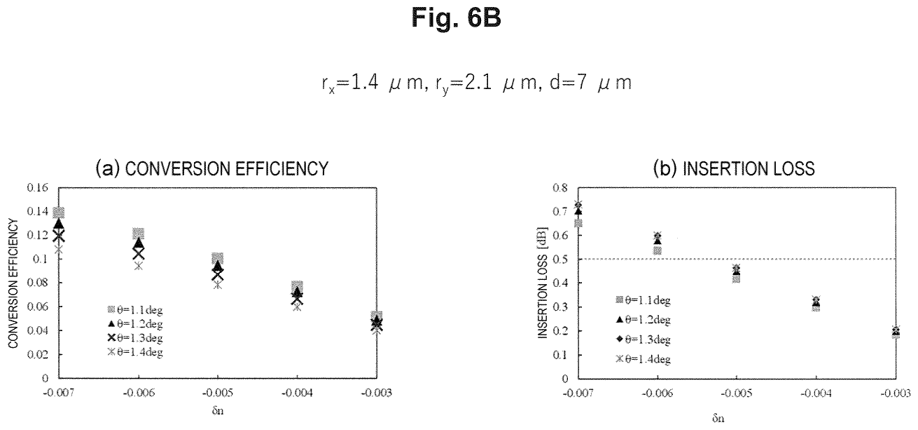

The characteristic dependence on the refractive index modulation amount on was evaluated. Here, rₓ=1.4 μm, r_{y}=2.1 μm, and d=7 μm were set. FIG. 6A(a) illustrates the conversion efficiency and FIG. 6A(b) illustrates the insertion loss when the refractive index modulation amount δn is changed to a positive value in the incidence in the LP₁₁ mode to the two-LP mode optical fiber. The insertion loss greatly depends on the refractive index modulation amount δn, and the insertion loss monotonically increases in proportion to δn. Since there is no parameter of which the loss is 0.5 dB or less in the range of δn>0.005, it is seen that it is necessary to set at least δn<0.005 in order to set the insertion loss to 0.5 dB or less. FIG. 6B(a) illustrates the conversion efficiency and FIG. 6B(b) illustrates the insertion loss when the refractive index modulation amount on is changed to a negative value. The insertion loss greatly depends on the refractive index modulation amount on, and the insertion loss monotonically increases in proportion to a decrease in on. Since there is no parameter of which the loss is 0.5 dB or less in the range of δn<−0.006, it is seen that it is necessary to set at least on >−0.006 in order to set the insertion loss to 0.5 dB or less.

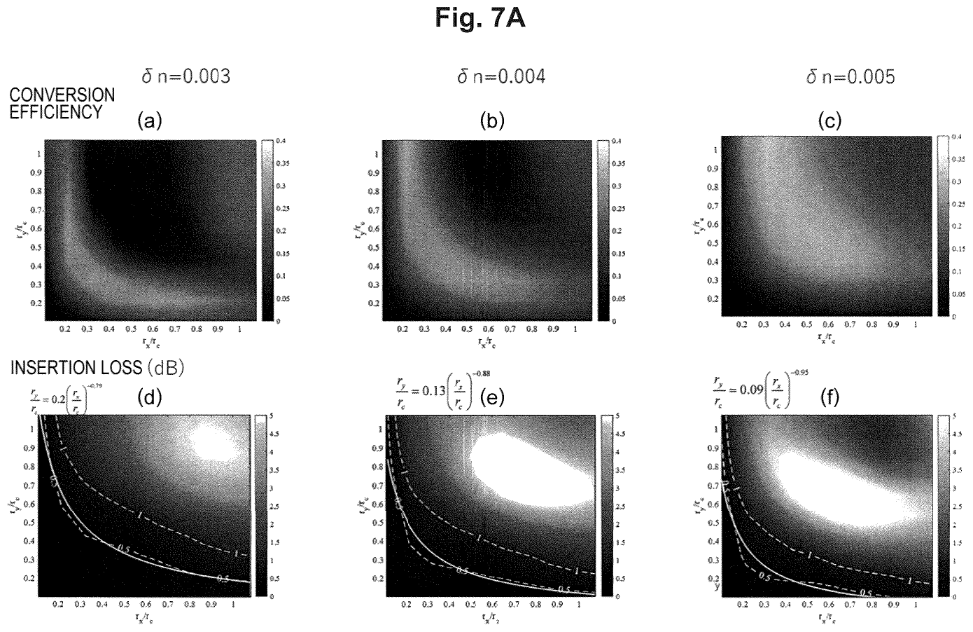

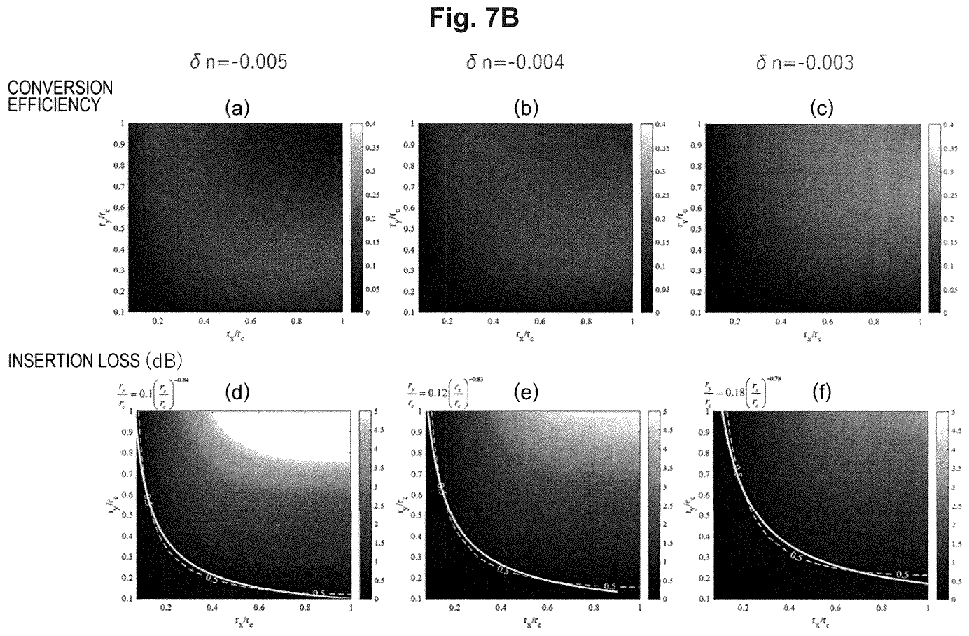

FIGS. 7A(a), 7A(b), and 7A(c) illustrate the conversion efficiencies and FIGS. 7A(d), 7A(e), and 7A(f) illustrate the insertion losses when rₓ/r_{c} and r_{y}/r_{c} are set as parameters in the incidence in the LP₁₁ mode to the two-LP mode optical fiber. Here, 0=1.3 deg, d=7 μm, and δn being a positive value were set. In FIGS. 7A(a) and 7A(d), δn=0.003, in FIGS. 7A(b) and 7A(e), δn=0.004, and in FIGS. 7A(c) and 7A(f), δn=0.005 were set. Contour lines with insertion losses of 0.5 dB and 1 dB are indicated by broken lines, and it can be seen that the insertion loss increases as rₓ and r_{y} increase. As a result, the insertion loss can be suppressed to 0.5 dB or less in the region at the lower left of the contour line. In the drawing, a contour line having an insertion loss of 0.5 dB is indicated by a white solid line approximate to an exponential function. Each of the contour lines is expressed by an approximate curve as follows.

$$In the case of δ n = 0.003 , {r}_{y} / {r}_{c} = 0.2 {( {r}_{x} / {r}_{c} )}^{- 0.79} \qquad ( A )$$

$$In the case of δ n = 0.004 , {r}_{y} / {r}_{c} = 0.13 {( {r}_{x} / {r}_{c} )}^{- 0.88} \qquad ( B )$$

$$In the case of δ n = 0.004 , {r}_{y} / {r}_{c} = 0.09 {( {r}_{x} / {r}_{c} )}^{- 0.95} \qquad ( C )$$

FIGS. 7B(a), 7B(b), and 7B(c) illustrate the conversion efficiencies and FIGS. 7B(d), 7B(e), and 7B(f) illustrate the insertion losses when rₓ/re and r_{y}/re are set as parameters in the incidence in the LP₁₁ mode to the two-LP mode optical fiber. Here, 0=1.3 deg, d=7 μm, and δn being a negative value were set. In FIGS. 7B(a) and 7B(d), δn=0.005, in FIGS. 7B(b) and 7B(e), δn=0.004, and in FIGS. 7B(c) and 7B(f), δn=0.003 were set. Contour lines with insertion losses of 0.5 dB are indicated by broken lines, and it can be seen that the insertion loss increases as rₓ and r_{y} increase. As a result, the insertion loss can be suppressed to 0.5 dB or less in the region at the lower left of the contour line. In the drawing, a contour line having an insertion loss of 0.5 dB is indicated by a white solid line approximate to an exponential function. Each of the contour lines is expressed by an approximate curve as follows.

$$In the case of δ n = 0.005 , {r}_{y} / {r}_{c} = 0.1 {( {r}_{x} / {r}_{c} )}^{- 0.84} \qquad ( A )$$

$$In the case of δ n = 0.004 , {r}_{y} / {r}_{c} = 0.12 {( {r}_{x} / {r}_{c} )}^{- 0.83} \qquad ( B )$$

$$In the case of δ n = 0.003 , {r}_{y} / {r}_{c} = 0.18 {( {r}_{x} / {r}_{c} )}^{- 0.78} \qquad ( C )$$

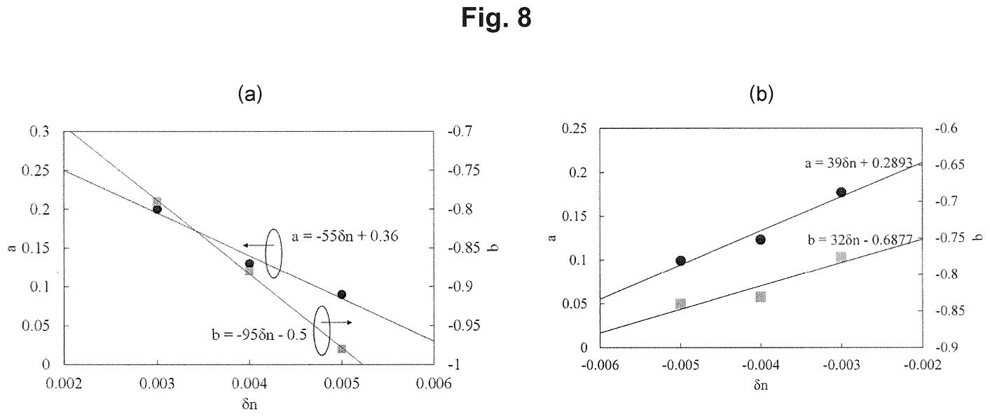

FIG. 8 illustrates a relationship between a, b, and on in a case of r_{y}/r_{c}=a (rₓ/r_{c})^{b}. FIG. 8(a) shows a case where on is positive, and FIG. 8(b) shows a case where on is negative. According to FIG. 8, the insertion loss can be suppressed by setting a and b to satisfy

$$if δ n > 0 ,$$

$$a = - 55 δ n + 0.36 and$$

$$b = - 95 δ n - 0.5 , and$$

$$if δ n < 0 ,$$

$$a = 39 δ n + 0.29 and$$

$$b = 32 δ n - 0.69$$

by setting rₓ and r_{y} to satisfy

$${r}_{y} / {r}_{c} = {a ( {r}_{x} / {r}_{c} )}^{b} .$$

In addition, according to FIGS. 7A(d), 7A(e), and 7A(f), it can be confirmed that there may be a region where the conversion efficiency is 10% or higher in a region where the insertion loss is 1 dB or less. Similarly, from FIGS. 7B(d), 7B(e), and 7B(f), it can be confirmed that there may be a region where the conversion efficiency is 10% or higher in a region where the insertion loss is 1 dB or less. Therefore, with respect to the two-LP mode optical fiber, it is possible to provide a short optical fiber-type mode converter that can convert a mode to a mode with a small loss and can shuffle modes by providing a refractive index modulation part provided to obliquely cross the core and having a different refractive index from a refractive index of the surroundings in the structure to satisfy

$$d / {r}_{c} >= 1.1 ,$$

$$1 deg < θ < 2 deg ,$$

$${r}_{y} / {r}_{c} < {a ( {r}_{x} / {r}_{c} )}^{b}$$

$$if 0 < δ n < 0.005 ,$$

$$a = - 55 δ n + 0.36 and$$

$$b = - 95 δ n - 0.5 , and satisfy$$

$$if - 0. 006 < δ n < 0 ,$$

$$a = 39 δ n + 0.29 and$$

$$b = 32 δ n - 0.69 .$$

### Third Embodiment

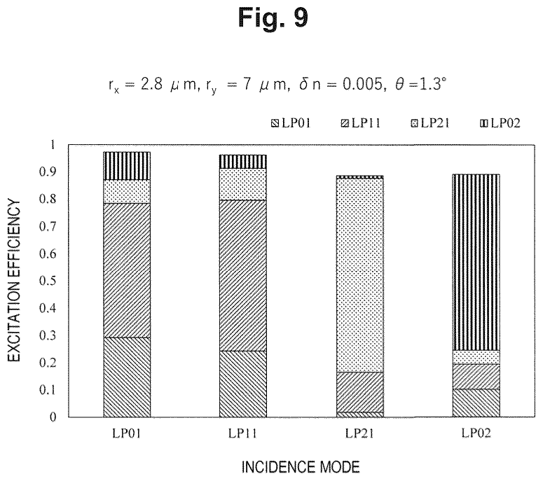

A fiber for propagation of four modes of LP₀₁, LP₁₁, LP₂₁, and LP₀₂ modes is considered. Considering the four-mode transmission in the C-band (1530 nm to 1565 nm), r_{c}=7 μm, and n_{core}=1.454215 (Δ_{core}=0.7%) are set herein. As an example, FIG. 9 illustrates the excitation efficiency in each mode after passing through the optical modulator in the case of incidence in each of the four modes of LP₀₁, LP₁₁, LP₂₁, and LP₀₂ modes when rₓ=2.8 μm, r_{y}=7 μm, δn=0.005, and θ=1.3 deg. It can be seen that each mode is converted into another mode. Since the LP₀₂ mode of the highest order has a smallest conversion efficiency and a largest insertion loss, the respective parameters are evaluated using the conversion efficiency and the insertion loss in the case of incidence in the LP₀₂ mode having a worse characteristic under the condition of propagation in the subsequent four LP modes.

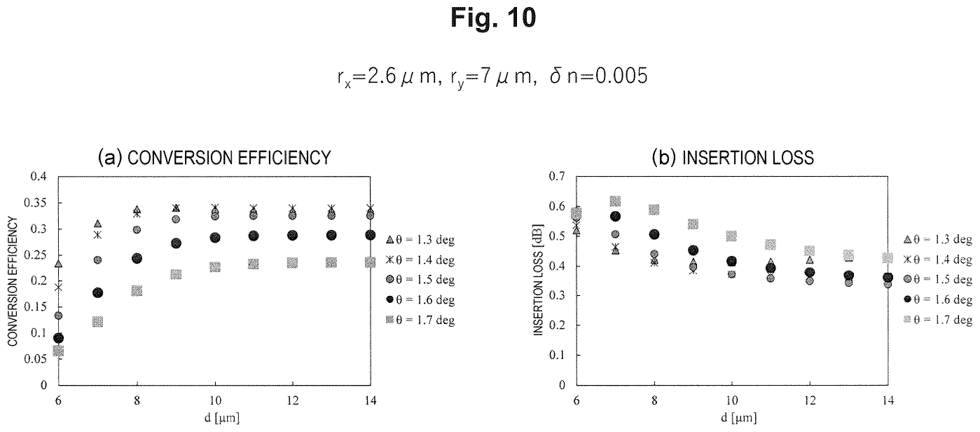

The effective range of each parameter was checked. First, the characteristic dependence on the distance d from the center of the core to the start point and the end point of the refractive index modulation part was evaluated. Here, FIG. 10(a) illustrates the conversion efficiency and FIG. 10(b) illustrates the insertion loss when the distance d is changed in the incidence in the LP₀₂ mode to the four-LP mode optical fiber when the distance d is changed as rₓ=2.6 μm, r_{y}=7.0 μm, and δn=0.005. In the region of d<10 μm, the conversion efficiency monotonically increases as the distance d increases, and the conversion efficiency is saturated around 10 μm. In addition, no large fluctuation is observed in the insertion loss in the region of d>=10 μm likewise. This shows that it is desirable to convert the mode in the range of d>=10 μm. When normalization is performed with the core radius r_{c}=7 μm, mode conversion can be performed with high efficiency in the range of d/r_{c}>=1.4.

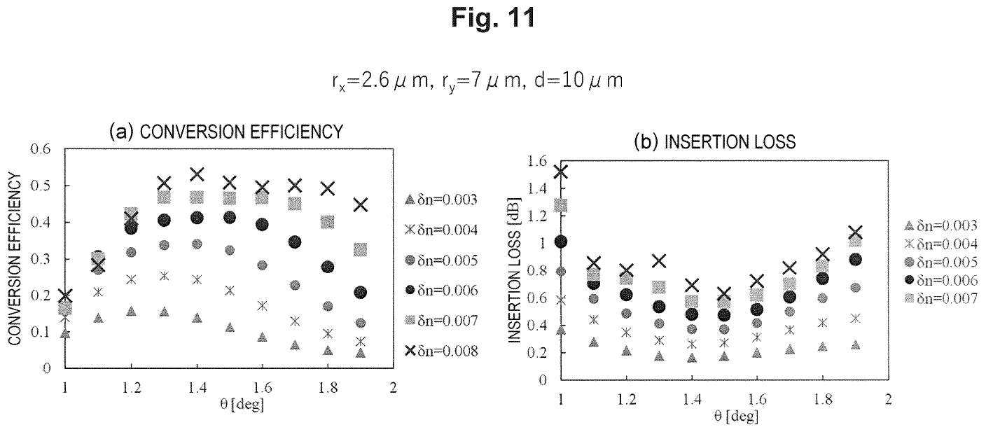

Subsequently, the characteristic dependence on the angle θ between the long axis of the core and the long axis of the refractive index modulation part was evaluated. Here, rₓ=2.6 μm, r_{y}=7 μm, and d=10 μm were set. FIG. 11(a) illustrates the conversion efficiency and FIG. 11(b) illustrates the insertion loss when the angle θ is changed in the incidence in the LP₀₂ mode to the four-LP mode optical fiber. It can be seen from FIG. 11(a) that the maximum value of the conversion efficiency is within the range of 1 deg<θ<2 deg. Similarly, it is seen that the minimum value of the insertion loss is in the range of 1 deg<θ<2 deg. Accordingly, θ needs to satisfy 1 deg<θ <2 deg. At this time, the length of the mode converter in the long axis direction is L=400 to 800 μm, and it is possible to realize a mode converter having a short length of about 1/30 as compared with an optical fiber-type mode converter using LPG of the related art.

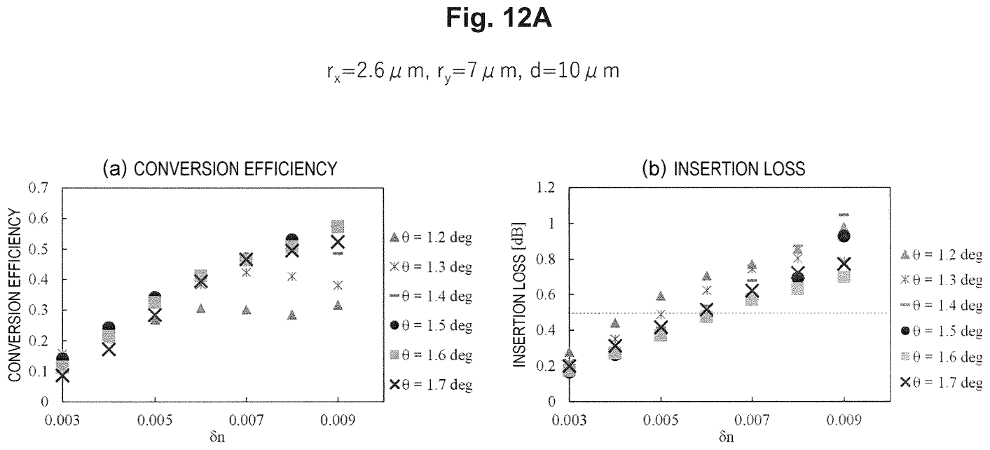

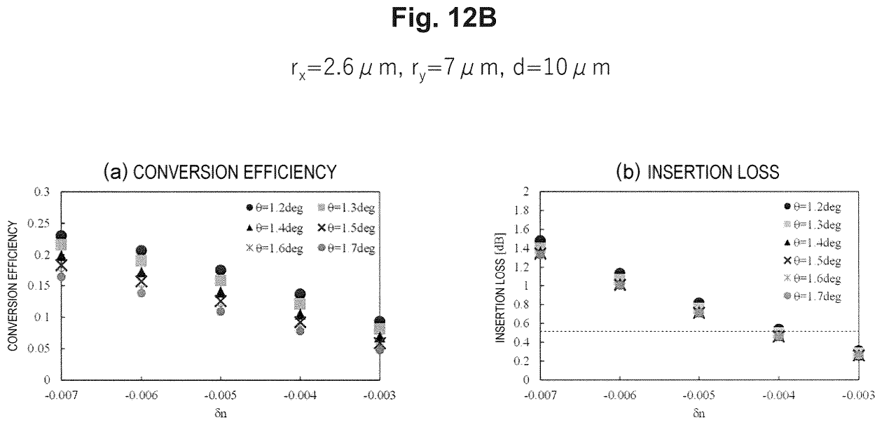

The characteristic dependence on the refractive index modulation amount on was evaluated. Here, rₓ=2.6 μm, r_{y}=7.0 μm, and d=10 μm were set. FIG. 12A(a) illustrates the conversion efficiency and FIG. 12A(b) illustrates the insertion loss when the refractive index modulation amount δn is changed to a positive value in the incidence in the LP₀₂ mode to the four-LP mode optical fiber. The insertion loss greatly depends on the refractive index modulation amount on. Since there is no parameter of which the loss is 0.5 dB or less in the range of δn>0.007, it is seen that it is necessary to set at least δn<0.007 in order to set the insertion loss to 0.5 dB or less.

FIG. 12B (a) illustrates the conversion efficiency and FIG. 12B (b) illustrates the insertion loss when the refractive index modulation amount on is changed to a negative value. The insertion loss greatly depends on the refractive index modulation amount on, and the insertion loss monotonically increases in proportion to a decrease in δn. Since there is no parameter of which the loss is 0.5 dB or less in the range of δn<−0.005, it is seen that it is necessary to set at least δn>−0.005 in order to set the insertion loss to 0.5 dB or less.

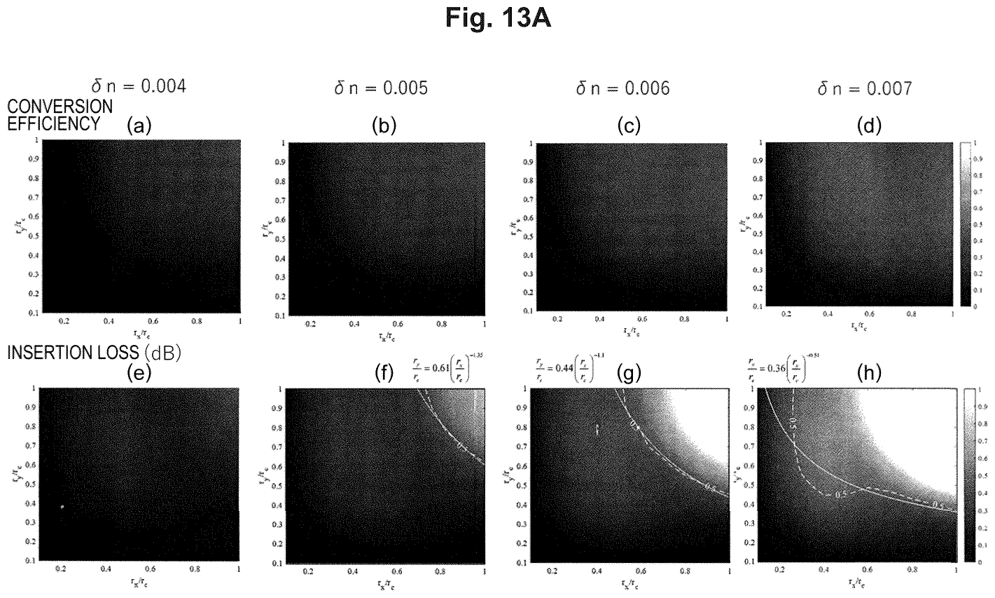

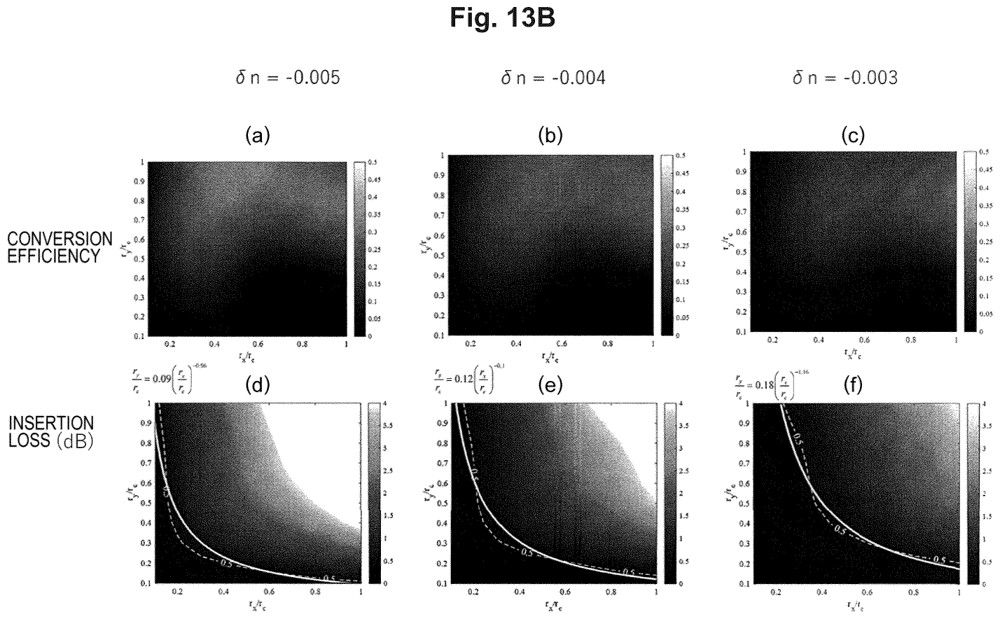

FIGS. 13A(a), 13A(b), 13A(c), and 13A(d) illustrate the conversion efficiencies and FIGS. 13A(e), 13A(f), 13A(g), and 13A(h) illustrate the insertion losses when rₓ/r_{c} and r_{y}/r_{c} are set as parameters in the incidence in the LP₀₂ mode to the four-LP mode optical fiber. Here, 0=1.4 deg, d=10 μm, and on being a positive value were set. In FIGS. 13A(a) and 13A(e), δn=0.004, in FIGS. 13A(b) and 13A(f), δn=0.005, in FIGS. 13A(c) and 13A(g), δn=0.006, and in FIGS. 13A(d) and 13A(h), δn=0.007 were set. Contour lines with insertion losses of 0.5 dB are indicated by broken lines, and it can be seen that the insertion loss increases as rₓ and r_{y} increase. As a result, the insertion loss can be suppressed to 0.5 dB or less in the region at the lower left of the contour line. In the case of δn=0.004, the insertion loss can be suppressed to 0.5 dB or less in the entire region of rₓ/r_{c}<1 and r_{y}/r_{c}<1. In the drawing, a contour line having an insertion loss of 0.5 dB is indicated by a white solid line approximate to an exponential function. Each of contour lines is expressed by an approximate curve as follows.

$$In the case of δ n = 0.005 , {r}_{y} / {r}_{c} = 0.61 {( {r}_{x} / {r}_{c} )}^{- 1.35} \qquad ( A )$$

$$In the case of δ n = 0.006 , {r}_{y} / {r}_{c} = 0.44 {( {r}_{x} / {r}_{c} )}^{- 1.1} \qquad ( B )$$

$$In the case of δ n = 0.007 , {r}_{y} / {r}_{c} = 0.36 {( {r}_{x} / {r}_{c} )}^{- 0.51} \qquad ( C )$$

FIGS. 13B(a), 13B(b), and 13B(c) illustrate the conversion efficiencies and FIGS. 13B(d), 13B(e), and 13B(f) illustrate the insertion losses when r_{y}/r_{c} and r_{y}/r_{c} are set as parameters in the incidence in the LP₀₂ mode to the four-LP mode optical fiber. Here, 0=1.4 deg, d=10 μm, and on being a negative value were set. In FIGS. 13B(a) and 13B(d), δn=−0.005, in FIGS. 13B(b) and 13B(e), δn=−0.004, and in FIGS. 13B(c) and 13B(f), δn=−0.003 were set. Contour lines with insertion losses of 0.5 dB are indicated by broken lines, and it can be seen that the insertion loss increases as rₓ and r_{y} increase. As a result, the insertion loss can be suppressed to 0.5 dB or less in the region at the lower left of the contour line. In the drawing, a contour line having an insertion loss of 0.5 dB is indicated by a white solid line approximate to an exponential function. Each of contour lines is expressed by an approximate curve as follows.

$$In the case of δ n = - 0.005 , {r}_{y} / {r}_{c} = 0.09 {( {r}_{x} / {r}_{c} )}^{- 0.96} \qquad ( A )$$

$$In the case of δ n = - 0.004 , {r}_{y} / {r}_{c} = 0.12 {( {r}_{x} / {r}_{c} )}^{- 0.1} \qquad ( B )$$

$$In the case of δ n = - 0.003 , {r}_{y} / {r}_{c} = 0.18 {( {r}_{x} / {r}_{c} )}^{- 1.16} \qquad ( C )$$

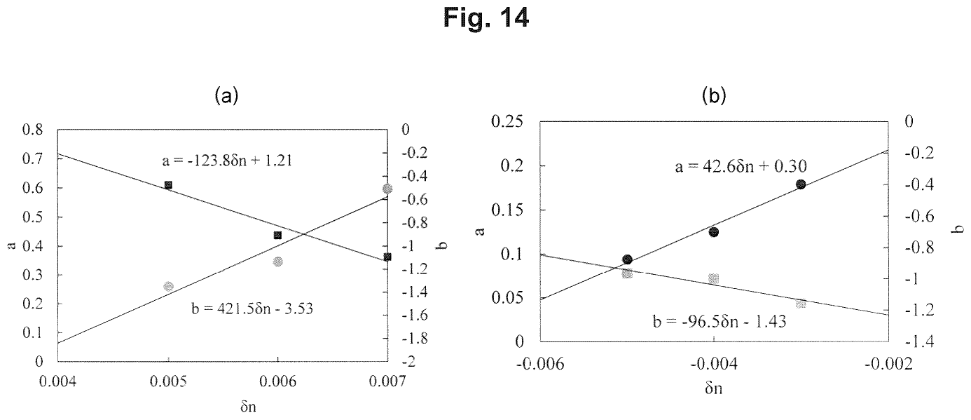

FIG. 14 illustrates a relationship between a, b, and δn in a case of r_{y}/r_{c}=a (rₓ/r_{c})^{b}. FIG. 14(a) shows a case where δn is positive, and FIG. 14(b) shows a case where δn is negative. According to FIG. 14(a), the loss can be suppressed by setting a and b to satisfy,

$$if δ n > 0 ,$$

$$a = - 123.8 δ n + 1.21 and$$

$$b = 421.5 δ n - 3.53 ,$$

by setting a and b to satisfy,

$$if δ n < 0 ,$$

$$a = 42.6 δ n + 0.3 and$$

$$b = - 96.5 δ n - 1.4 , and$$

by setting rₓ and r_{y} to satisfy

$${r}_{y} / {r}_{c} < {a ( {r}_{x} / {r}_{c} )}^{b} .$$

In addition, according to FIGS. 13A and 13B, it can be confirmed that there may be a region where the conversion efficiency is 40% or higher in a region where the insertion loss is 0.5 dB or less. Therefore, with respect to the four-LP mode optical fiber, it is possible to provide a short optical fiber-type mode converter that can convert a mode to a mode with a small loss and can shuffle modes by providing a refractive index modulation part provided to obliquely cross the core and having a different refractive index from a refractive index of the surroundings in the structure to satisfy

$$d / {r}_{c} >= 1.4 ,$$

$$1 deg < θ < 2 deg ,$$

$${r}_{y} / {r}_{c} < {a ( {r}_{x} / {r}_{c} )}^{b}$$

$$if 0 < δ n < 0.007 ,$$

$$a = - 123.8 δ n + 1.21 and$$

$$b = 421.5 δ n - 3.53 , and to satisfy ,$$

$$if - 0. 005 < δ n < 0 ,$$

$$a = 42.6 δ n + 0.3 and$$

$$b = - 96.5 δ n - 1.4 .$$

Although the examples of the two-LP mode optical fiber and the four-LP mode optical fiber have been described in the present embodiment, it is also possible to provide a short optical fiber-type mode converter also for other multi-mode optical fibers.

### Fourth Embodiment

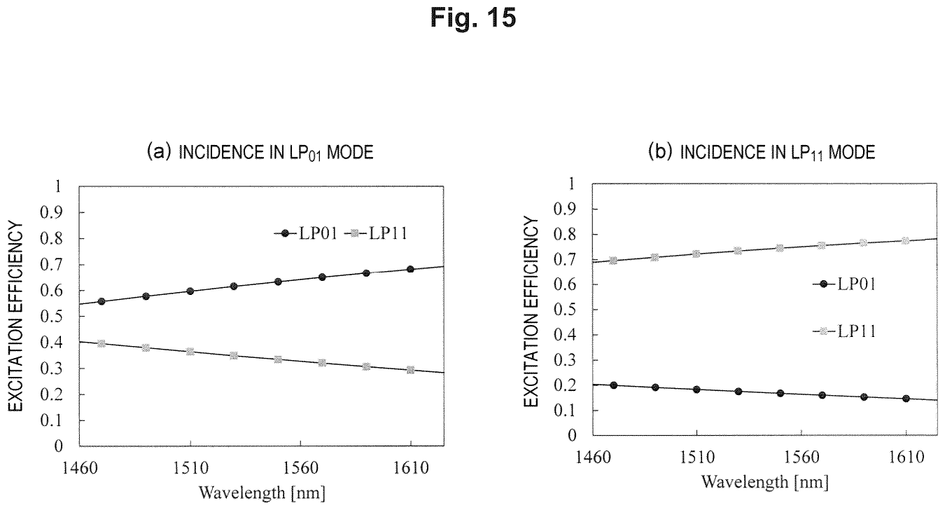

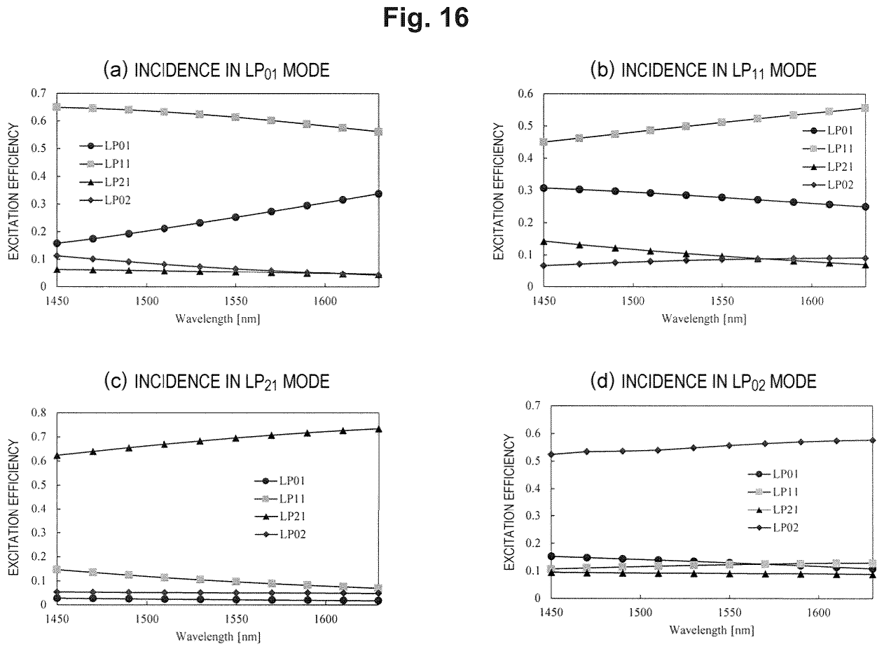

FIG. 15 illustrates wavelength characteristics of excitation efficiency in a case where the refractive index modulation part is provided in the two-LP mode optical fiber described in the first embodiment. FIG. 16 illustrates wavelength characteristics of excitation efficiency in a case where the refractive index modulation part is provided in the four-LP mode optical fiber described in the second embodiment. Assuming S+C+L band transmission, wavelength characteristics at 1450 nm to 1625 nm are illustrated.

FIG. 15(a) illustrates the excitation efficiency when light is incident in the LP₀₁ mode, and FIG. 15(b) illustrates the excitation efficiency when light is incident in the LP₁₁ mode, where rₓ=1.4 μm, r_{y}=2.1 μm, d=7 μm, θ=1.3 deg, and δn=0.004 were set. FIG. 16(a) illustrates the excitation efficiency when light is incident in the LP₀₁ mode, FIG. 16(b) illustrates the excitation efficiency when light is incident in the LP₁₁ mode, FIG. 16(c) illustrates the excitation efficiency when light is incident in the LP₂₁ mode, and FIG. 16(d) illustrates the excitation efficiency when light is incident in the LP₀₂ mode where rₓ=2.6 μm, r_{y}=7.0 μm, d=10 μm, θ=1.4 deg, and δn=0.005 were set.

In both cases of the two-LP mode optical fiber or the four-LP mode optical fiber, although the conversion efficiency in conversion to another mode to the short wavelength side is higher depending on the mode, it can be seen that the mode can be converted in the entire band of 1460 nm to 1625 nm. The reason that the conversion efficiency is higher on the short wavelength side is considered that conversion is likely to occur on the short wavelength side because the effective refractive index difference between modes is smaller.

By providing the refractive index modulation part that is provided to obliquely cross the core and has a different refractive index from a refractive index of the surroundings, it is possible to provide an optical fiber-type mode converter having small wavelength dependency.

Although the examples of the two-LP mode optical fiber and the four-LP mode optical fiber have been described in the present embodiment, it is also possible to provide an optical fiber-type mode converter having small wavelength dependency also for other multi-mode optical fibers.

### Fifth Embodiment

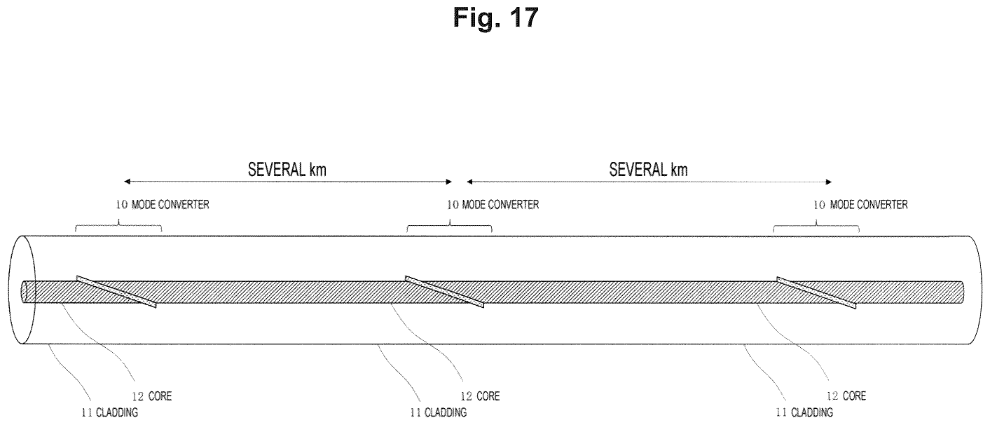

Taking advantage of the short optical fiber type having small wavelength dependency, for example, when an optical fiber transmission line in which the mode converter 10 is provided every several kilometers in the middle of an optical fiber of several 10 km is used as illustrated in FIG. 17, it is considered that the mode is converted on average. In FIG. 17, reference numeral 10 denotes a mode converter, reference numeral 11 denotes a cladding, and reference numeral 12 denotes a core. Although the coupling amount generated using one refractive index modulation part is about 10 to 20%, by providing the mode converters in multiple stages in the optical fiber transmission line, the mode can be uniformly shuffled in the entire optical fiber transmission line and the mode group delay difference and the inter-mode loss difference can be reduced.

### Sixth Embodiment

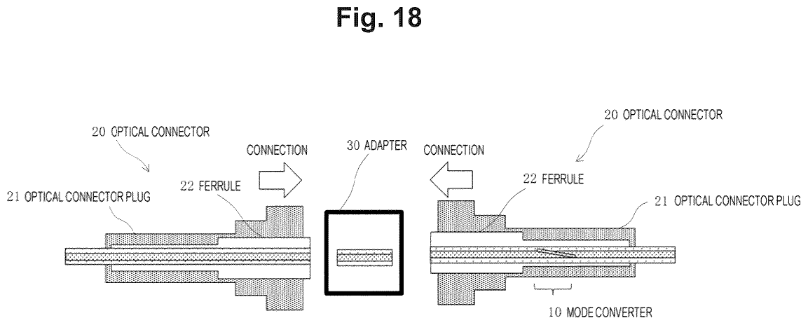

When the mode converter of the present disclosure is disposed in an optical component by taking advantage of the short optical fiber type having small wavelength dependency, it is possible to provide a function of shuffling the modes with a small optical component. FIG. 18 illustrates an example in which the mode converter of the present disclosure is disposed in an optical connector, for example. In FIG. 18, reference numeral 10 denotes a mode converter, reference numeral 20 denotes an optical connector, reference numeral 21 denotes an optical connector plug, reference numeral 22 denotes a ferrule, and reference numeral 30 denotes an optical adapter. When the mode converter 10 of the present disclosure is disposed in the ferrule 22, the mode for propagation through the optical connector plug 21 is shuffled.

### Seventh Embodiment

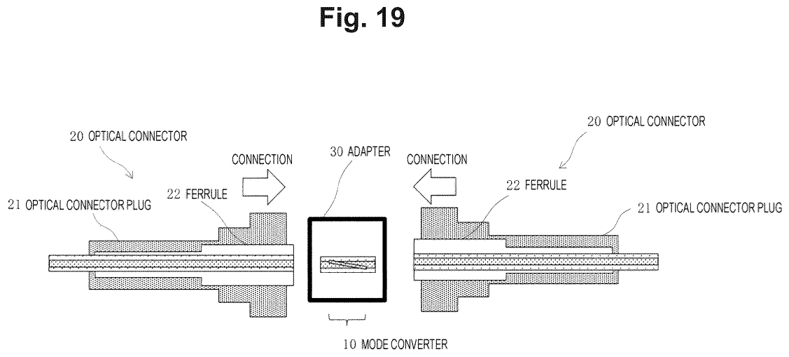

FIG. 19 illustrates an example in which the mode converter of the present disclosure is disposed in an optical adapter. In FIG. 19, reference numeral 10 denotes a mode converter, reference numeral 20 denotes an optical connector, reference numeral 21 denotes an optical connector plug, reference numeral 22 denotes a ferrule, and reference numeral 30 denotes an optical adapter. When the mode converter 10 of the present disclosure is disposed on an optical propagation path in the optical adapter 30, the mode for propagation through the optical adapter 30 is shuffled.

### Eighth Embodiment

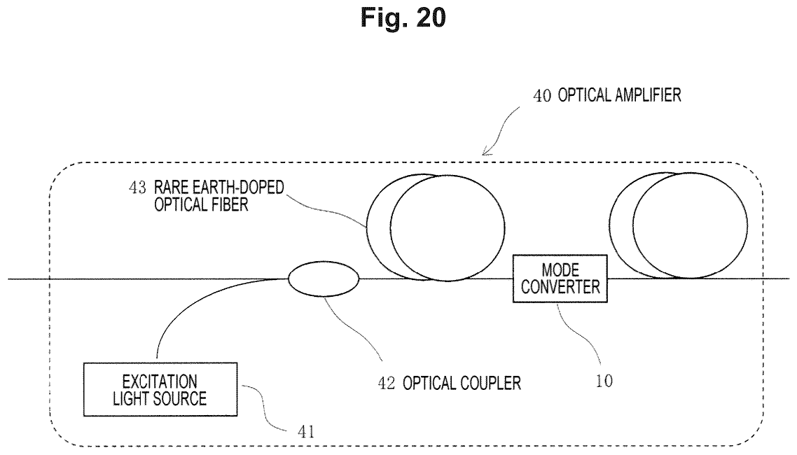

FIG. 20 illustrates an example in which the mode converter of the present disclosure is disposed in an optical amplifier. In FIG. 20, reference numeral 10 denotes a mode converter, reference numeral 40 denotes an optical amplifier, reference numeral 41 denotes an excitation light source, reference numeral 42 denotes an optical coupler, and reference numeral 43 denotes a rare earth-doped optical fiber. Light to be amplified and excitation light from the excitation light source 41 are multiplexed by the optical coupler 42, and the light to be amplified is optically amplified by the rare earth-doped optical fiber 43. When the mode converter 10 of the present disclosure is disposed in the optical propagation path in the optical amplifier 40, the mode is shuffled by the mode converter 10, and the inter-mode gain difference and the loss difference are averaged in a repeater. The mode converter 10 may be disposed at any position of the front part and the rear part of the rare earth-doped optical fiber 43 or in the middle of the rare earth-doped optical fiber 43. Although FIG. 20 illustrates an example of the optical fiber amplifier, the same applies to a semiconductor amplifier.

### Ninth Embodiment

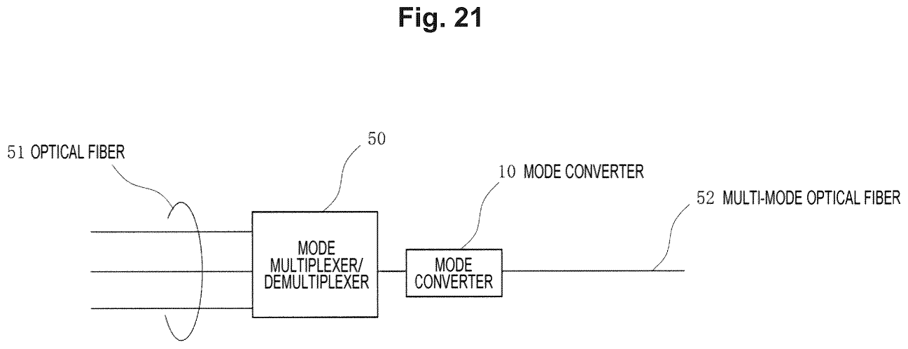

FIG. 21 illustrates an example in which the mode converter of the present disclosure is disposed in a mode multiplexer/demultiplexer. In FIG. 21, reference numeral 10 denotes a mode converter, reference numeral 50 denotes a mode multiplexer/demultiplexer, reference numeral 51 denotes an optical fiber, and reference numeral 52 denotes a multi-mode optical fiber. A terminal to which light of the single mode is input from a plurality of optical fibers 51 is referred to as a single mode end, and a terminal to which light of the multi-mode is output in the multi-mode optical fiber 52 is referred to as a multi-mode end. When single-mode light beams input from the plurality of optical fibers 51 to the single-mode end are multiplexed by the mode multiplexer/demultiplexer 50 and multi-mode light beams are output from the multi-mode end to the multi-mode optical fiber 52, if the mode is shuffled by the mode converter of the present disclosure, distribution between the modes is uniformized. The same applies to a case where multi-mode light is demultiplexed into single-mode light.

As described above, the mode converter of the present disclosure can be configured to have small wavelength dependency and a short length.

### INDUSTRIAL APPLICABILITY

The present disclosure can be applied to communications industries.

### REFERENCE SIGNS LIST

10 Mode converter
11 Cladding
12 Core
13 Refractive index modulation part
20 Optical connector
21 Optical connector plug
22 Ferrule
30 Optical adapter
40 Optical amplifier
41 Excitation light source
40 Light coupler
43 Rare earth-doped optical fiber
50 Mode multiplexer/demultiplexer

1. A mode converter comprising:
a cladding having a constant refractive index;
a core having a refractive index higher than the refractive index of the cladding in the cladding; and
a refractive index modulation part provided to obliquely cross the core and having a different refractive index from a refractive index of surroundings.

2. The mode converter according to claim 1, wherein
the core has a structure in which propagation in two LP modes is performed, and satisfies
$$d / {r}_{c} > = 1 \text{.1} ,$$
$$1 deg < θ < 2 deg ,$$
$${r}_{y} / {r}_{c} < {a ( {r}_{x} / {r}_{c} )}^{b}$$
$$if 0 < δ n < 0.0 \; 05 ,$$
$$a = - 55 δ n + 0.36 and$$
$$b = - 95 δ n - 0.5 , and$$
$$if - 0.006 < δ n < 0 ,$$
$$a = 39 δ n + 0.29 and$$
$$b = 32 δ n - 0.69 ,$$
wherein d is a distance between the center of an end of the refractive index modulation part and the long axis of the core, r_{c} is a radius of the core, θ is an angle formed by the long axis of the refractive index modulation part and the long axis of the core, δn is a refractive index modulation amount, rₓ is a radius of the refractive index modulation part in an x direction, r_{y} is a radius of the refractive index modulation part in a y direction, the refractive index modulation amount is a difference between the refractive index of the refractive index modulation part and the refractive index of surroundings of the refractive index modulation part, the x direction is a direction that is parallel to the plane including the long axis of the core and the long axis of the refractive index modulation part and perpendicular to the long axis of the core, and the y direction is a direction perpendicular to the plane including the long axis of the core and the long axis of the refractive index modulation part.

3. The mode converter according to claim 1, wherein
the core has a structure in which propagation in four LP modes is performed, and satisfies
$$d / {r}_{c} > = 1.4 ,$$
$$1 deg < θ < 2 deg ,$$
$${r}_{y} / {r}_{c} < {a ( {r}_{x} / {r}_{c} )}^{b}$$
$$if 0 < δ n < 0.007 ,$$
$$a = - 123.8 δ n + 1.21 and$$
$$b = 421.5 δ n - 3.53 , and$$
$$if - 0.005 < δ n < 0 ,$$
$$a = 42.6 δ n + 0.3 and$$
$$b = - 96.5 δ n - 1.4 ,$$
wherein d is a distance between the center of an end of the refractive index modulation part and the long axis of the core, r_{c} is a radius of the core, θ is an angle formed by the long axis of the refractive index modulation part and the long axis of the core, δn is a refractive index modulation amount, rₓ is a radius of the refractive index modulation part in an x direction, r_{y} is a radius of the refractive index modulation part in a y direction, the refractive index modulation amount is a difference between the refractive index of the refractive index modulation part and the refractive index of surroundings of the refractive index modulation part, the x direction is a direction that is parallel to the plane including the long axis of the core and the long axis of the refractive index modulation part and perpendicular to the long axis of the core, and the y direction is a direction perpendicular to the plane including the long axis of the core and the long axis of the refractive index modulation part.

4. An optical fiber transmission line, wherein the mode converter according to claim 1 is provided in multiple stages in the middle of an optical fiber.

5. An optical connector, wherein the mode converter according to claim 1 is provided in a ferrule.

6. An optical adapter, wherein the mode converter according to claim 1 is provided on an optical propagation path.

7. An optical amplifier, wherein the mode converter according to claim 1 is provided on an optical propagation path.

8. A mode multiplexer/demultiplexer, wherein the mode converter according to claim 1 is provided at a multi-mode end.
